(19) United States
(12) Patent Application Publication
(10) Pub. No.: US 2016/0276120 A1
(43) Pub. Date: Sep. 22, 2016

(54) SYSTEMS AND METHODS FOR ENERGY SAVING CONTACTOR

(71) Applicants: Juan Manuel ARCAS, Móstoles (Madrid) (ES); John Francis NEWPORT, Móstoles (Madrid) (ES); Goretti FARRÉ LOZANO, Garching b. Munenchen (DE); Jorge GARCÍA RODRÍGUEZ, Móstoles (Madrid) (ES); GENERAL ELECTRIC COMPANY, Schenectady, NY (US)

(72) Inventors: Juan Manuel Arcas, Madrid (ES); John Francis Newport, Madrid (ES); Goretti Farre Lozano, Garching b. Munenchen (DE); Jorge Garcia Rodriguez, Madrid (ES)

(73) Assignee: General Electric Company, Schenectady, NY (US)

(21) Appl. No.: 14/429,621

(22) PCT Filed: Mar. 21, 2013
(86) PCT No.: PCT/ES2014/070209

§ 371 Date: Mar. 19, 2015

(51) Int. Cl. H01H 47/00; H01H 50/32; H01H 47/22; H01H 50/62

(52) U.S. Cl. CPC H01H 47/001; H01H 50/62; H01H 50/32; H01H 47/22

(57) ABSTRACT

A control circuit for an energy saving contactor including at least one power contact is provided. The control circuit includes a power supply unit, an energy storage circuit coupled to the power supply unit, a first transducer coupled to the power supply unit and configured to switch the at least one power contact from an open armature position to a closed armature position, a latch system configured to maintain the at least one power contact in the closed armature position, a second transducer coupled to the power supply unit and configured to disengage the latch system to cause the at least one power contact to switch from the closed armature position to the open armature position, and a controller configured to control electrical power supplied from the power supply to the first and second transducers to selectively activate the first and second transducers based on monitored input voltage conditions.

### BACKGROUND

The field of the invention relates generally to electrical contactors and more particularly to controlling operation of electrical contactors.

Electrical contactors are switched to control the distribution of the electrical power between a power source and at least one load. Contactors include at least one power contact (i.e., switch) that may be selectively opened or closed to interrupt or supply electrical power flowing from the power source to the load. The load may be, for example, an electric motor, a lighting device, a heating device, an appliance, or another electrically-powered device.

At least some known contactors generally include an electromagnetic coil that when energized, switches the positioned of the power contacts. To maintain this state, the electromagnetic coil must be constantly powered. As a consequence, conventional contactors typically consume relatively high amounts of electrical power. Although at least some known contactors include mechanical devices to hold the power contacts of the contactor in a closed armature position, these contactors may still need a separate control circuit to release a latched state of the mechanical devices.

### BRIEF DESCRIPTION

In one aspect, a control circuit for an energy saving contactor that includes at least one power contact is provided. The control circuit includes a power supply unit, an energy storage circuit electrically coupled to the power supply unit, a first transducer electrically coupled to the power supply unit and configured to switch the at least one power contact from an open armature position to a closed armature position, a latch system configured to maintain the at least one power contact in the closed armature position, a second transducer electrically coupled to the power supply unit and configured to disengage the latch system to cause the at least one power contact to switch from the closed armature position to the open armature position, and a controller configured to control electrical power supplied from the power supply to the first and second transducers to selectively activate the first and second transducers.

In another aspect, a controller is provided. The controller is for use in an energy saving contactor control circuit that includes a power supply unit, an energy storage circuit electrically coupled to the power supply unit, a first transducer configured to switch at least one power contact from an open armature position to a closed armature position, a latch system configured to maintain the at least one power contact in the closed armature position, and a second transducer configured to disengage the latch system to cause the at least one power contact to switch from the closed armature position to the open armature position. The controller is configured to compare an input voltage from a power source to a first predetermined voltage, cause electrical power to be supplied to the first transducer when the input voltage is greater than the first predetermined voltage, compare the input voltage from the power source to a second predetermined voltage, and cause electrical power to be supplied to the second transducer from the energy storage circuit when the input voltage is less than the second predetermined voltage.

In yet another aspect, a method for controlling operation of an energy saving contactor that includes at least one power contact is provided. The method includes comparing, using a controller, an input voltage from a power source to a first predetermined voltage, supplying, using the controller, electrical power to a first transducer when the input voltage is greater than the first predetermined voltage, wherein electrical power is supplied to the first transducer to switch the at least one power contact from an open armature position to a closed armature position, maintaining the at least one power contact in the closed armature position using a latch system, comparing, using the controller, the input voltage from the power source to a second predetermined voltage, and supplying, using the controller, electrical power to a second transducer when the input voltage is less than the second predetermined voltage, wherein electrical power is supplied to the second transducer such that the second transducer disengages the latch system to switch the at least one power contact from the closed armature position to the open armature position.

### BRIEF DESCRIPTION OF THE DRAWINGS

FIG. 1 is a perspective view of an exemplary contactor.

FIG. 2 is a schematic diagram of an exemplary contactor control circuit in a first state that may be used with the contactor shown in FIG. 1.

FIG. 3 is a schematic diagram of the contactor control circuit shown in FIG. 2 in a second state.

FIG. 4 is a schematic diagram of the contactor control circuit shown in FIG. 2 in a third state.

FIG. 5 is a schematic diagram of the contactor control circuit shown in FIG. 2 in a fourth state.

FIG. 6 is a schematic diagram of the contactor control circuit shown in FIG. 2 in a fifth state.

FIG. 7 is a schematic diagram of the contactor control circuit shown in FIG. 2 in a sixth state

FIG. 8 is a functional schematic of an exemplary implementation of the contactor control circuit shown in FIG. 2.

FIG. 9 is a flowchart of an exemplary method for controlling a contactor.

### DETAILED DESCRIPTION

Exemplary embodiments of controlling a contactor to achieve energy savings for the contactor are described herein. A contactor control circuit includes a power supply, an energy storage system coupled to the power supply, a controller, a first transducer configured to switch at least one power contact from an open armature position to a closed armature position, a latch system configured to maintain the at least one power contact in the closed armature position, and a second transducer configured to disengage the latch system such that the least one power contact switches from the closed armature position to the open armature position. The controller controls electrical power supplied to the first and second transducers to selectively activate the first and second transducers and control operation of the contactor.

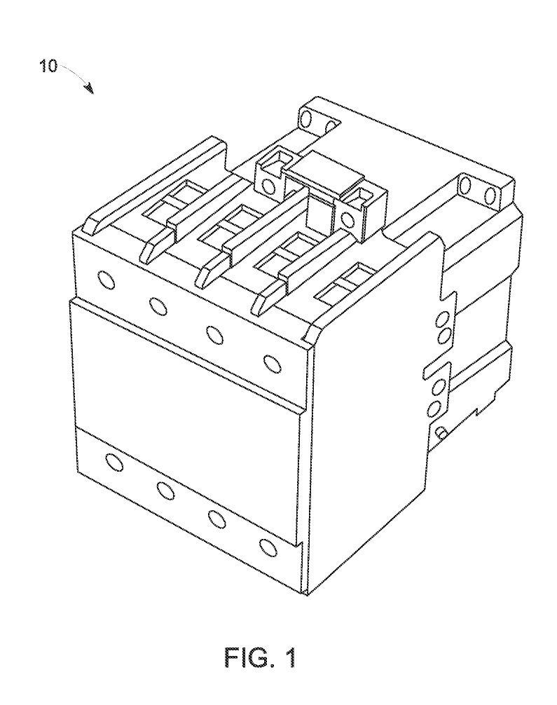

FIG. 1 is a perspective view of an exemplary contactor 10. Contactor 10 uses at least one power contact (not shown in FIG. 1) to control distribution of electrical power to at least one load. The load may include, for example, an electric motor, a lighting device, a heating device, and/or other devices that operate using electrical power. A controller (not shown in FIG. 1) controls a position of the power contacts of contactor 10, as described herein.

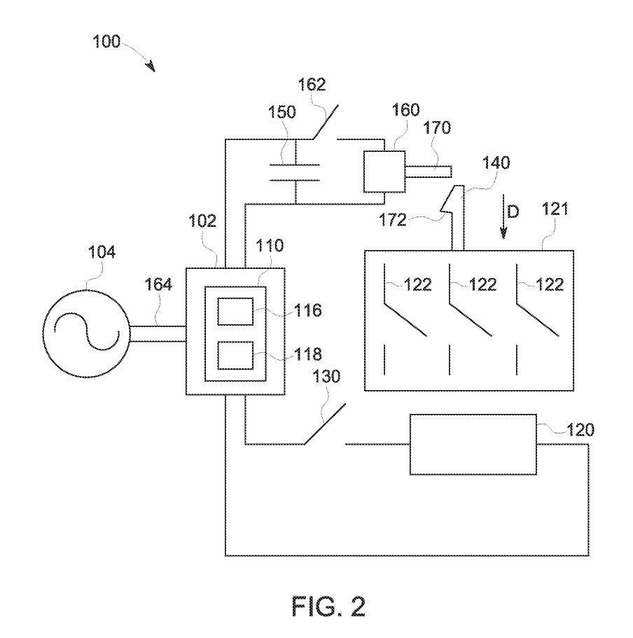

FIG. 2 is a schematic diagram of an exemplary contactor control circuit 100 that may be used with contactor 10 (shown in FIG. 1). In the exemplary embodiment, contactor control circuit 100 includes a voltage detector 102 coupled to an alternating current (AC) voltage source 104, or mains. Alternatively, voltage detector 102 may be coupled to a direct current (DC) voltage source. In the exemplary embodiment, AC voltage source 104 is external to contactor 10 (shown in FIG. 1).

In the first state of the control circuit 100 (shown in FIG. 2), a voltage detector 102 is used. Specifically, a controller 110 (also referred to herein as a “management system”) compares a voltage across AC voltage source 104 to one or more reference voltages, and controls operation of contactor control circuit 100 based on the comparisons, as described herein. In the exemplary embodiment, controller 110 is implemented within voltage detector 102. Alternatively, controller 110 may be a separate hardware component communicatively coupled to voltage detector 102.

In the exemplary embodiment, controller 110 is implemented by a processor 116 coupled to a memory device 118 for executing instructions. In some embodiments, executable instructions are stored in memory device 118. Alternatively, controller 110 may be implemented using active circuitry (e.g., comparators), passive circuitry (e.g., a resistive or capacitive divider and pull up or pull down diodes), and/or integrated circuitry to control operation of components of contactor control circuit 100.

In the exemplary embodiment, controller 110 performs one or more operations described herein by programming processor 116. For example, processor 116 may be programmed by encoding an operation as one or more executable instructions and by providing the executable instructions in memory device 118. Processor 116 may include one or more processing units (e.g., in a multi-core configuration). Further, processor 116 may be implemented using one or more heterogeneous processor systems in which a main processor is present with secondary processors on a single chip. As another illustrative example, processor 116 may be a symmetric multi-processor system containing multiple processors of the same type. Further, processor 116 may be implemented using any suitable programmable circuit including one or more systems and microcontrollers, microprocessors, reduced instruction set circuits (RISC), application specific integrated circuits (ASIC), programmable logic circuits, field programmable gate arrays (FPGA), and any other circuit capable of executing the functions described herein. In the exemplary embodiment, processor 116 causes controller 110 to operate one or more components of contactor control circuit 100, as described herein.

In the exemplary embodiment, memory device 118 is one or more devices that enable information such as executable instructions and/or other data to be stored and retrieved. Memory device 118 may include one or more computer readable media, such as, without limitation, dynamic random access memory (DRAM), static random access memory (SRAM), a solid state disk, and/or a hard disk. Memory device 118 may be configured to store, without limitation, application source code, application object code, source code portions of interest, object code portions of interest, configuration data, execution events and/or any other type of data.

Contactor control circuit 100 includes an electromagnetic contactor coil 120 electrically coupled to voltage detector 102. Contactor control circuit 100 interfaces with a mechanical system 121 of a convention contactor that includes an armature (not shown) having at least one power contact 122. Each power contact 122 is a switching device switchable between an open armature position and a closed armature position. FIG. 2 is a schematic diagram of contactor control circuit 100 in a first, or initial, state where controller 110 monitors the input voltage conditions. As shown in FIG. 2, in the first state, power contacts 122, relay 130, and relay 162 are in the open position. Although referred to herein as relays, relays 130 and 162 may each be any switching device (e.g., relay, transistor, etc.) that contactor control circuit 100 to function as described herein.

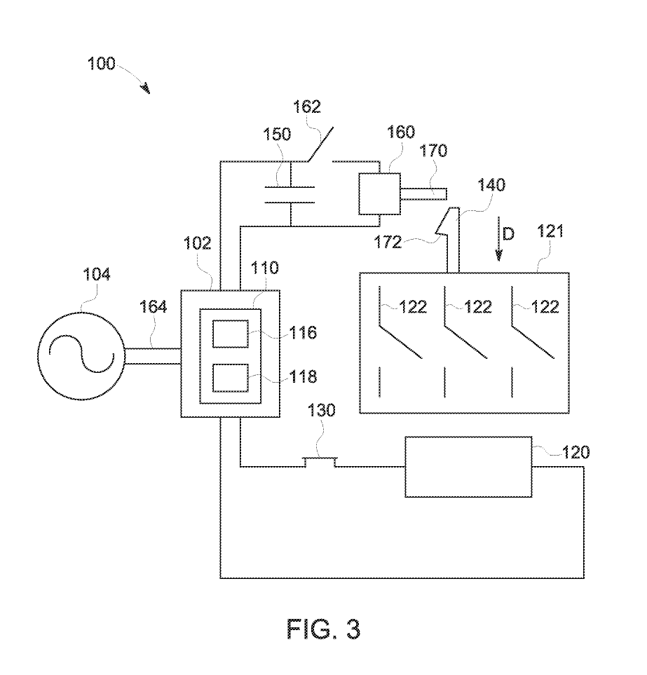

In the first state, controller 110 uses voltage detector 102 to compare an input voltage across AC voltage source 104 to a first predetermined voltage, Vpick_up. The value of Vpick_up may be stored, for example, on memory device 118. If the input voltage is greater than Vpick_up, controller 110 closes a first relay 130 electrically coupled between voltage detector 102 and contactor coil 120. FIG. 3 shows contactor control circuit 100 in a second state, at the instant where first relay 130 is closed.

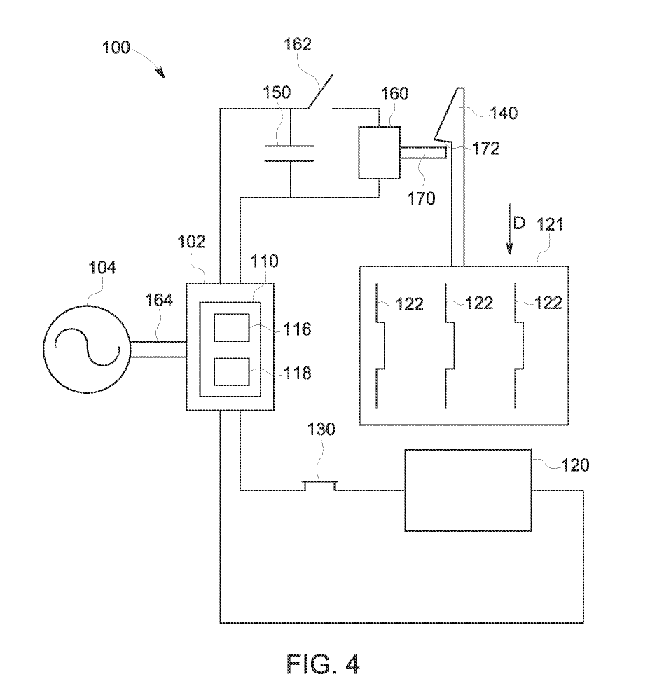

As shown in FIG. 4, closing first relay 130 causes electrical power from AC voltage source 104 to activate contactor coil 120, which in turn closes an armature of power contacts 122 (i.e., switches power contacts 122 from the open armature position to the closed armature position), placing contactor control circuit 100 in a third state. Although contactor control circuit 100 utilizes an electromagnetic contactor coil to close the armature in the exemplary embodiment, alternatively, contactor control circuit 100 may utilize any transducer (e.g., a piezoelectric actuator) configured to close power contacts 122 as described herein. Notably, when the armature is closed, a mechanical latch mechanism 140 is extended, and a ledge 172 of mechanical latch mechanism 140 engages a pin 170, locking mechanical latch mechanism 140 in place. That is, switching of power contacts 122 is synched with movement of mechanical latch mechanism 140. Accordingly, mechanical latch mechanism 140 and ledge 172 form a self-locking latch system. Because the position of mechanical latch mechanism 140 shown in FIG. 4 maintains power contacts 122 in the closed armature position, contactor coil 120 may be deactivated once power contacts 122 are switched to the closed armature position.

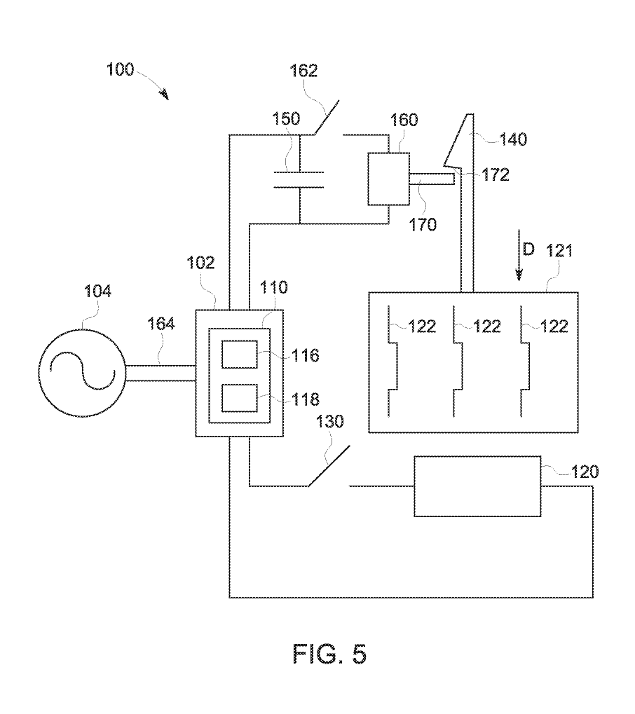

FIG. 5 is a schematic diagram of contactor control circuit 100 in a fourth state, in which first relay 130 has been re-opened. Specifically, in the exemplary embodiment, first relay 130 is closed for a relatively short time such that contactor coil 120 activates to close power contacts 122, but does not remain activated for an extended period of time. For example, first relay 130 may be closed for approximately 200 milliseconds (ms). Notably, the time before first relay 130 re-opens may be constant or variable. Controller 110 may control the re-opening of first relay 130, or alternatively, first relay 130 may incorporate a timer that causes first relay 130 to open after a predetermined amount of time. This facilitates minimizing power consumption by contactor control circuit 100, as described herein.

Once first relay 130 is re-opened (e.g., after approximately 200 ms), contactor coil 120 is deactivated. With contactor coil 120 deactivated, in the second state, a mechanical latch mechanism 140 holds power contacts 122 in the closed position. Specifically, mechanical latch mechanism 140 hooks power contacts 122 in the closed position when contactor coil 120 is activated, and maintains power contacts 122 in the closed position without consuming electrical power once contactor coil 120 is deactivated. Without mechanical latch mechanism 140, power contacts 122 would return to the open position once contactor coil 120 was deactivated.

In the fourth state shown in FIG. 5, electrical power from AC voltage source 104 is supplied to a capacitor 150 that is electrically coupled to voltage detector 102. Although contactor control circuit 100 includes a capacitor 150 in the exemplary embodiment, alternatively, contactor control circuit 100 may include any type of energy storage circuit that enables contactor control circuit 100 to function as described herein. For example, instead of capacitor 150, the energy storage circuit may include an LC circuit, an RC circuit, an RLC circuit, a spring, a pneumatic device, a hydraulic device, and/or any other components for storing and discharging electrical energy as described herein.

Capacitor 150 begins to charge in the first state (shown in FIG. 2), and continues to charge through the second, third, and fourth states. As power is supplied to capacitor 150 by a trickle current from AC voltage source 104, electrical energy is built up and stored on capacitor 150. Trickle charging of capacitor 150 may be continuous or may be periodically topped up when capacitor 150 is fully charged. In one embodiment, controller 110 controls charging of capacitor 150. Capacitor 150 is coupled in parallel with an electromagnetic latch coil 160. As shown in FIG. 3, a second relay 162 is electrically coupled between capacitor 150 and latch coil 160. When second relay 162 is open, as shown in FIG. 3, capacitor stores electrical energy, and latch coil 160 is deactivated. When second relay 162 is closed, latch coil 160 is activated, as described herein.

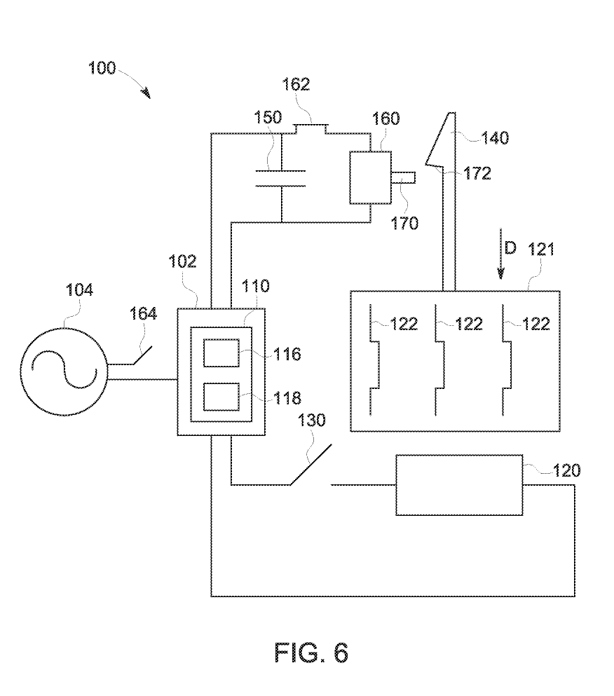

With contactor control circuit 100 in the fourth state shown in FIG. 5, controller 110 uses voltage detector 102 to compare the input voltage across AC voltage source 104 to a second predetermined voltage, Vdrop_out. The value of Vdrop_out may be stored, for example, on memory device 118. Vdrop_out may be the same or different from Vpick_up. If the input voltage falls below Vdrop_out, contactor control circuit 100 opens power contacts 122 (i.e., switches power contacts 122 from the closed armature position to the open armature position). The input voltage may fall below Vdrop_out, for example, when a third relay 164 between AC voltage source 104 and voltage detector 102 is open. In the exemplary embodiment, as shown in FIG. 6, third relay 164 is external to contactor 10 (shown in FIG. 1).

FIG. 6 shows contactor control circuit 100 in a fifth state subsequent to voltage detector 102 determining that the input voltage has fallen below Vdrop_out. Specifically, when voltage detector 102 determines that the input voltage is less than Vdrop_out, controller 110 closes second relay 162, as shown in FIG. 6. This causes electrical energy stored in capacitor 150 to be discharged into latch coil 160, activating latch coil 160. Activating latch coil 160 causes mechanical latch mechanism 140 to disengage, which in turn will open power contacts 122. Although contactor control circuit 100 utilizes an electromagnetic latch coil in the exemplary embodiment, alternatively, contactor control circuit 100 may utilize any transducer (e.g., a piezoelectric actuator) configured to disengage latch mechanism 140 as described herein.

In the exemplary embodiment, activating latch coil 160 causes pin 170 to be retracted. The fifth state shown in FIG. 6 shows the instant at which pin 170 is retracted. Mechanical latch mechanism 140 is biased (e.g., using a spring or other biasing device) to move in a direction, D. However, in the fourth state (shown in FIG. 5), pin 170 engages ledge 172 defined on mechanical latch mechanism 140, preventing mechanical latch mechanism 140 from moving in the direction D.

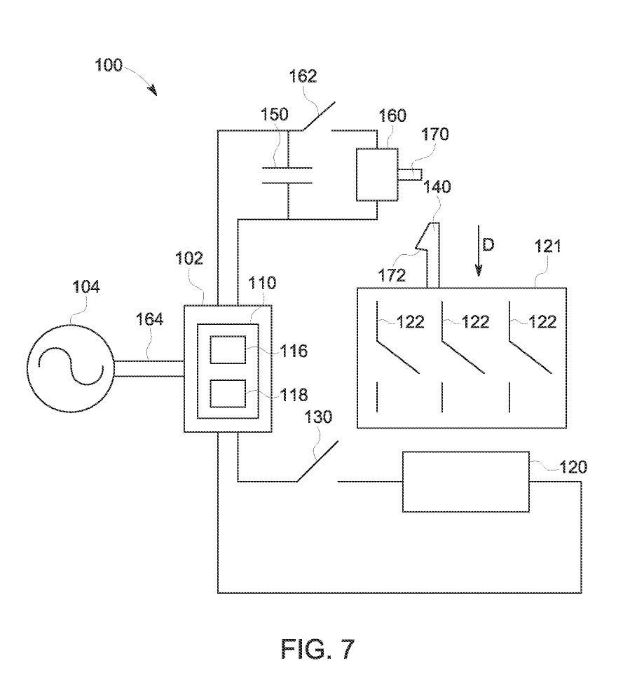

FIG. 7 shows a sixth state of contactor control circuit 100. As shown in FIG. 7, after pin 170 retracts and disengages ledge 172, mechanical latch mechanism 140 moves in direction D and open power contacts 122 (i.e., opens the armature of power contacts 122). Alternatively, activating latch coil 160 may cause disengagement of mechanical latch mechanism 140 in any manner than enables contactor control circuit 100 to function as described herein. Accordingly, as shown in FIG. 7, in the sixth state, power contacts 122 are in the open armature position. Notably, the sixth state shown in FIG. 7 is substantially similar to the first state shown in FIG. 2. With second relay 162 open, trickle charging of capacitor 150 recommences. Accordingly, the states of contactor control circuit 100 shown in FIGS. 2-7 cover the complete operational cycle of contactor control circuit 100.

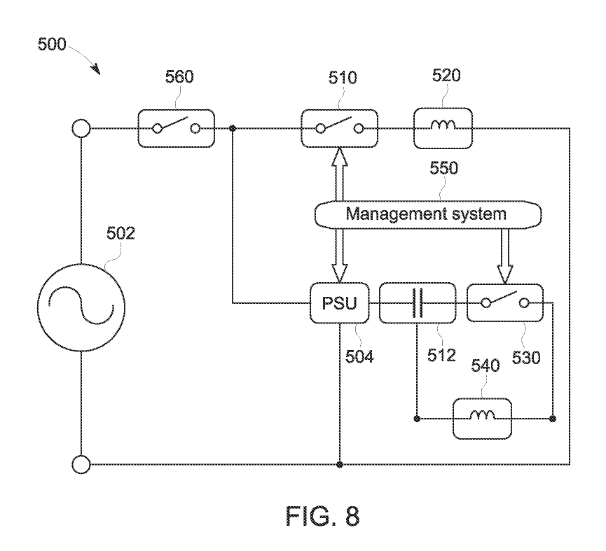

FIG. 8 is a functional schematic of an exemplary implementation 500 of contactor control circuit 100 (shown in FIGS. 2-7). Implementation 500 includes an external AC source 502, such as AC voltage source 104 (shown in FIGS. 2-7), in the exemplary embodiment. Alternatively, implementation 500 may include a DC voltage source. In the exemplary embodiment, AC source 502 supplies an AC voltage in a range from 20 VAC to 220 VAC. Alternatively, AC source 502 supplies any amount of AC voltage that enables implementation 500 to function as described herein. AC source 502 is coupled to a power supply unit 504. Power supply unit 504 powers one or more components of implementation 500. Power supply unit 504 may be, for example, a linear or voltage switched regulator.

As shown in FIG. 8, power supply unit 504 is coupled to a first switch 510, such as first relay 130 (shown in FIGS. 2-7), and an energy storage circuit 512, such as capacitor 150 (shown in FIGS. 2-7). Instead of capacitor 150, energy storage circuit 512 may alternatively include an LC circuit, an RC circuit, an RLC circuit, a spring, a pneumatic device, a hydraulic device, and/or any other components for storing and discharging electrical energy as described herein. First switch 510 is coupled between power supply unit 504 and a first coil 520 (i.e., a first transducer), such as contactor coil 120 (shown in FIGS. 2-7). Accordingly, first switch 510 controls whether electrical energy is supplied to first coil 520. First switch 510 may be any switching device (e.g., relay, transistor, etc.) that enables implementation 500 to function as described herein.

A second switch 530, such as second relay 162 (shown in FIGS. 2-7), is coupled between energy storage circuit 512 and a second coil 540 (i.e., a second transducer), such as latch coil 160 (shown in FIGS. 2-7). Accordingly, second switch 530 controls whether electrical energy from energy storage circuit 512 is discharged into second coil 540. Second switch 530 may be any switching device (e.g., relay, transistor, etc.) that enables implementation 500 to function as described herein.

A control device 550, such as controller 110 (shown in FIGS. 2-7), is communicatively coupled to power supply unit 504, first switch 510, and second switch 530. Control device 550 monitors input voltage conditions, and controls operation of first switch 510 and second switch 530 based on those conditions, as described above in reference to FIGS. 2-7. In the exemplary embodiment, control device 550 also controls power supply unit 504.

Implementation 500 includes a test switch 560 in the exemplary embodiment. Test switch 560 enables a user to selectively test implementation 500. Specifically, test switch 560 enables a user to control whether AC source 502 supplies power to power supply unit 504. By manipulating test switch 560, the user can observe the operation of control device 550, first switch 510, and second switch 530 to determine whether these components are functioning properly. In the exemplary embodiment, test switch 560 is a mechanical switch. Alternatively, test switch 560 may be implemented using passive and/or active circuitry.

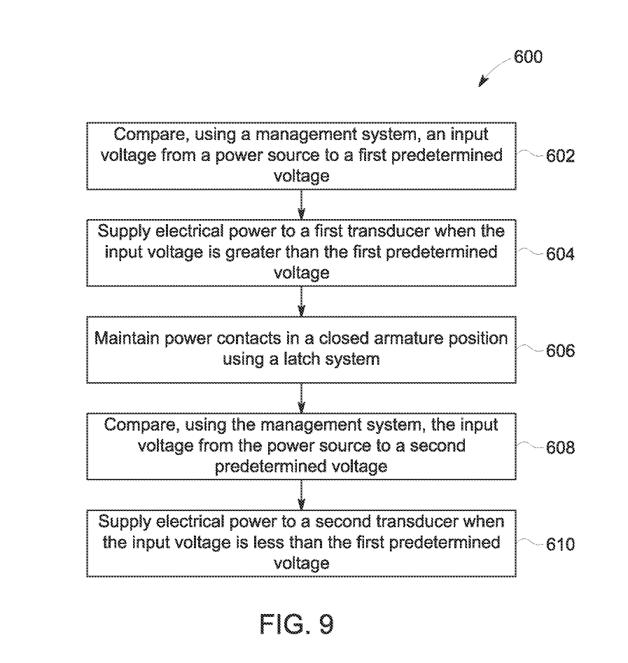

FIG. 9 is a flowchart of an exemplary method 600 for controlling an energy saving contactor, such as contactor 10 (shown in FIG. 1). Method 600 includes, comparing 602 an input voltage from a power source, such as AC source 502 (shown in FIG. 8), to a first predetermined voltage. The input voltage is compared 602 to the first predetermined voltage using a management system (e.g., a controller), such as control device 550 (shown in FIG. 8). When the input voltage is greater than the first predetermined voltage, using the management system, electrical power is supplied 604 to a first transducer, such as first coil 520 (shown in FIG. 8). Electrical power is supplied 604 to the first transducer such that the first transducer switches at least one power contact, such as power contacts 122 (shown in FIGS. 2-7), from an open armature position to a closed armature position.

A latch system, such as mechanical latch mechanism 140 (shown in FIGS. 2-7), maintains 606 the at least one power contact in the closed armature position. With the power contacts in the closed armature position, the management system compares 608 the input voltage from the power source to a second predetermined voltage. When the input voltage is less than the second predetermined voltage, using the management system, electrical power is supplied 610 to a second transducer, such as second coil 540 (shown in FIG. 8). For example, a capacitor, such as capacitor 150 (shown in FIGS. 2-7) may charge over a period of time, and then discharge to supply power to the second transducer. Electrical power is supplied 610 to the second transducer such that the second transducer disengages the latch system, which in turn switches at least one power contact from the closed armature position to the open armature position.

Additional variations and/or modifications of contactor control circuit 100 are within the spirit and scope of the disclosure. For example, in some embodiments, contactor control circuit 100, and more particularly, controller 110, includes a communication interface. The communication interface facilitates communications between contactor control circuit 100 and one or more remote devices using a wireless connection, a wired connection, an optical fiber connection, and/or other suitable connections. To communicate with remote devices, the communication interface may include, for example, a wired network adapter, a wireless network adapter, a radio-frequency (RF) adapter, and/or a mobile telecommunications adapter. Moreover, in some embodiments, one or more components of contactor control circuit 100 may be encapsulated in a protective housing. The housing may be hermetically sealed to facilitate preventing damage to components of contactor control circuit 100 due to environmental conditions that may interfere with device operation, such as pressure, vibration, and/or humidity. In some embodiments, to assist with heat transfer, the housing may include an insulating liquid such, as a fluorocarbon-based fluid, and/or a thermally loaded material. Further, one or more coating materials may be applied to the housing to facilitate enhancing protection against magnetic fields, electric fields, and/or ionizing radiation. Moreover, electrical components in contactor control circuit 100 may be selected to facilitate enhancing performance.

As compared to at least some known contactors, the systems and methods described herein facilitate using relatively little power to maintain an armature in a closed position. To close the armature of at least one power contact, power is supplied to a contactor coil for a relatively short period of time (i.e., at least enough time to latch the system). After the period of time expires, the contactor coil deactivates, and the at least one power contact is held in a closed armature position by a self-locking latch system, which does not consume electrical energy. During this hold state, the only components of the contactor control circuit described herein that consume power are a voltage detector and a capacitor, as well as any power consumed by a management system (e.g., a controller). Accordingly, while at least some known contactors require more than 8.0 volt-amperes (VA) to hold power contacts in a closed armature position, the contactor control circuit described herein may facilitate holding power contacts in a closed armature position using less than 1.0 VA. Further the contactor control circuit described herein integrates a controller, a contactor coil, a latch coil, and a mechanical latch into the same circuit. Accordingly, at least some of the components of the contactor control circuit may be combined in an external, auxiliary module that can be used to retro-fit existing contactors relatively quickly and easily to include energy saving advantages. As such, the system described herein may be implemented within the geometry of a conventional contactor housing, or alternatively, may be implemented with the addition of an external auxiliary module.

Exemplary embodiments of systems and methods for controlling a contactor are described above in detail. The systems and methods are not limited to the specific embodiments described herein but, rather, components of the systems and/or operations of the methods may be utilized independently and separately from other components and/or operations described herein. Further, the described components and/or operations may also be defined in, or used in combination with, other systems, methods, and/or devices, and are not limited to practice with only the systems described herein.

The order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A control circuit for an energy saving contactor that includes at least one power contact, said control circuit comprising:
a power supply unit;
an energy storage circuit electrically coupled to said power supply unit;
a first transducer electrically coupled to said power supply unit and configured to switch the at least one power contact from an open armature position to a closed armature position;
a latch system configured to maintain the at least one power contact in the closed armature position;
a second transducer electrically coupled to said power supply unit and configured to disengage said latch system to cause the at least one power contact to switch from the closed armature position to the open armature position; and
a controller configured to control electrical power supplied from said power supply to said first and second transducers to selectively activate said first and second transducers.

2. A control circuit in accordance with claim 1, further comprising a switch electrically coupled between said power supply unit and said first transducer, wherein said controller is communicatively coupled to said switch and configured to operate said switch to control electrical power supplied to said first transducer.

3. A control circuit in accordance with claim 1, further comprising a switch electrically coupled between said energy storage circuit and said second transducer, wherein said controller is communicatively coupled to said switch and configured to operate said switch to control electrical power supplied to said second transducer such that when said switch is closed, said second transducer uses energy stored in said energy storage circuit to disengage said latch system.

4. A control circuit in accordance with claim 1, wherein said energy storage circuit comprises a capacitor configured to charge and subsequently discharge to supply power to said second transducer, and wherein said control circuit is configured such that when the energy saving contactor is in a power saving mode, said controller is powered, said capacitor receives a trickle charge, and said first transducer is not powered.

5. A control circuit in accordance with claim 1, further comprising a test switch that enables a user to selectively test operation of said control circuit.

6. A control circuit in accordance with claim 1, wherein said latch system comprises a self-locking mechanical latch configured to maintain the at least one power contact in the closed armature position such that a need to constantly power said first transducer is avoided and such that said first transducer does not consume power while said self-locking mechanical latch maintains the at least one power contact in the closed armature position.

7. A control circuit in accordance with claim 1, wherein to control electrical power supplied to said first and second transducers, said controller is configured to:
compare an input voltage from a power source to a first predetermined voltage;
cause electrical power to be supplied to said first transducer when the input voltage is greater than the first predetermined voltage;
compare the input voltage from the power source to a second predetermined voltage; and
cause electrical power to be supplied to said second transducer when the input voltage is less than the second predetermined voltage.

8. A controller for use in an energy saving contactor control circuit that includes a power supply unit, an energy storage circuit electrically coupled to the power supply unit, a first transducer configured to switch at least one power contact from an open armature position to a closed armature position, a latch system configured to maintain the at least one power contact in the closed armature position, and a second transducer configured to disengage the latch system to cause the at least one power contact to switch from the closed armature position to the open armature position, said controller configured to:
compare an input voltage from a power source to a first predetermined voltage;
cause electrical power to be supplied to the first transducer when the input voltage is greater than the first predetermined voltage;
compare the input voltage from the power source to a second predetermined voltage; and
cause electrical power to be supplied to the second transducer from the energy storage circuit when the input voltage is less than the second predetermined voltage.

9. A controller in accordance with claim 8, wherein to cause electrical power to be supplied to the first transducer, said controller is configured to close a switch electrically coupled between the power source and the first transducer.

10. A controller in accordance with claim 8, wherein to cause electrical power to be supplied to the second transducer, said controller is configured to close a switch electrically coupled between the energy storage circuit and the second transducer such that the second transducer uses energy stored in the energy storage circuit to disengage the latch system.

11. A controller in accordance with claim 8, wherein to cause electrical power to be supplied to the first transducer, said controller is configured to cause electrical power to be supplied to an electromagnetic coil.

12. A controller in accordance with claim 8, wherein said controller comprises a communication interface to facilitate communications with at least one remote device.

13. A controller in accordance with claim 8, wherein said controller is configured to cause electrical power to be supplied to the first transducer long enough to switch the at least one power contact to the closed armature position.

14. A method for controlling operation of an energy saving contactor that includes at least one power contact, said method comprising:
comparing, using a controller, an input voltage from a power source to a first predetermined voltage;
supplying, using the controller, electrical power to a first transducer when the input voltage is greater than the first predetermined voltage, wherein electrical power is supplied to the first transducer to switch the at least one power contact from an open armature position to a closed armature position;
maintaining the at least one power contact in the closed armature position using a latch system;
comparing, using the controller, the input voltage from the power source to a second predetermined voltage; and
supplying, using the controller, electrical power to a second transducer when the input voltage is less than the second predetermined voltage, wherein electrical power is supplied to the second transducer such that the second transducer disengages the latch system to switch the at least one power contact from the closed armature position to the open armature position.

15. A method in accordance with claim 14, wherein supplying electrical power to the first transducer comprises closing a switch electrically coupled between a power supply unit and the first transducer.

16. A method in accordance with claim 14, wherein supplying electrical power to the second transducer comprises closing a switch electrically coupled between an energy storage circuit and the second transducer such that the second transducer uses energy stored in the energy storage circuit to disengage the latch system.

17. A method in accordance with claim 16, wherein closing a switch comprises closing a switch coupled between a capacitor and the second transducer.

18. A method in accordance with claim 14, wherein maintaining the at least one power contact in the closed armature position using a latch system comprises maintaining the at least one power contact in the closed armature position using a self-locking mechanical latch such that a need to constantly power the first transducer is avoided and such that the first transducer does not consume power while the self-lacking mechanical latch maintains the at least one power contact in the closed armature position.

19. A method in accordance with claim 14, wherein supplying electrical power to the second transducer comprises supplying electrical power to an electromagnetic coil.

20. A method in accordance with claim 16, wherein supplying electrical power to the first transducer comprises supplying electrical power to the first transducer for a period of time long enough to switch the at least one power contact to the closed armature position.
